(19) United States
(12) Patent Application Publication
(10) Pub. No.: US 2024/0070644 A1
(43) Pub. Date: Feb. 29, 2024

(54) AUTOMATED DATA CAPTURE PROCESSING

(71) Applicant: Visa International Service Association, San Francisco, CA (US)

(72) Inventor: Gavin Shenker, Los Angeles, CA (US)

(73) Assignee: Visa International Service Association, San Francisco, CA (US)

(21) Appl. No.: 17/898,347

(22) Filed: Aug. 29, 2022

(51) Int. Cl. G06Q 20/32

(52) U.S. Cl. CPC G06Q 20/3267

(57) ABSTRACT

A method is disclosed. The method includes presenting, by a user device, a completion page for a transaction to a user; capturing, by the user device, an image of the completion page; storing, by the user device, completion page image data for the image of the completion page; and presenting, by the user device, transaction data for the transaction along with the image of completion page to the user, the image of the completion page generated using the stored completion page image data.

### CROSS-REFERENCES TO RELATED APPLICATIONS

None.

### BACKGROUND

Users conducting online interactions with entities such as governmental entities, merchants, and the like, may desire specific proof that such interactions were completed. In one example, a user that conducts transactions such as an e-commerce or in-app payment transactions may not be able to remember performing them. The user reviewing a monthly statement of transactions may not be able to remember the specifics of some of the listed transactions. If they cannot remember those transactions, they may be under impression that they are fraudulent when they are not. The user may then contact the authorizing entity (e.g., an issuer) that authorized the transactions on the user's behalf and may erroneously report the transactions as being fraudulent. This can be problematic and time consuming as many additional unnecessary communications would result from the user's mistaken belief. In another example, a user may conduct an interaction with an entity that requires the input of a specific type of information to complete a process such as a registration process. The user may believe that they completed the process. However, if the user is mistaken, then the entity may inform the user did not complete the process.

Embodiments of the invention address these and other problems individually and collectively.

### BRIEF SUMMARY

One embodiment of the invention includes a method including: presenting, by a user device, a completion page for a transaction to a user; capturing, by the user device, an image of the completion page; storing, by the user device, completion page image data for the image of the completion page; and presenting, by the user device, transaction data for the transaction along with the image of the completion page to the user, the image of the completion page generated using the stored completion page image data.

Another embodiment of the invention includes a user device comprising: a processor; and a non-transitory computer readable medium coupled to the processor and containing instructions for causing the processor to perform operations comprising: presenting a completion page for a transaction to a user; capturing an image of the completion page; storing completion page image data for the image of the completion page; and presenting transaction data for the transaction along with the image of the completion page to the user, the image of the completion page generated using the stored completion page image data.

Another embodiment of the invention includes a method comprising: receiving, by an authorizing entity computer from a user device, completion page image data for an image of a completion page associated with a transaction conducted by a user; receiving, by the authorizing entity computer, an authorization request message for the transaction; determining, by the authorizing entity computer, transaction data based on the authorization request message; matching, by the authorizing entity computer, the completion page image data for the image of the completion page with the transaction data; and providing, by the authorizing entity computer to the user device, the transaction data for the transaction along with the image of the completion page to the user.

Another embodiment of the invention includes an authorizing entity computer comprising a processor; and a non-transitory computer-readable medium comprising code, executable by the processor to perform operations including: receiving, by an authorizing entity computer from a user device, completion page image data for an image of a completion page associated with a transaction conducted by a user; receiving, by the authorizing entity computer, an authorization request message for the transaction; determining, by the authorizing entity computer, transaction data based on the authorization request message; matching, by the authorizing entity computer, the completion page image data for the image of the completion page with the transaction data; and providing, by the authorizing entity computer to the user device, the transaction data for the transaction along with the image of the completion page to the user.

Further details regarding embodiments of the invention can be found in the Detailed Description and the Figures.

### BRIEF DESCRIPTION OF THE DRAWINGS

FIG. 1 shows a block diagram of a system according to an embodiment.

FIG. 2 shows a block diagram of a user device according to an embodiment.

FIG. 3 shows a block diagram of an authorizing entity computer according to an embodiment.

FIG. 4 shows a flowchart illustrating methods according to embodiments.

FIG. 5A shows an image of an exemplary completion page in the form of a confirmation page according to an embodiment.

FIG. 5B shows an image of an exemplary completion page in the form of a checkout page according to an embodiment.

FIG. 6 shows a page with transaction data and a link to image date for a completion page according to an embodiment.

### DETAILED DESCRIPTION

Prior to discussing embodiments of the invention, some terms can be described in further detail.

A “user” may include an individual. In some embodiments, a user may be associated with one or more personal accounts and/or user devices.

A “user device” may be any suitable device that is operated by a user. Suitable user devices can be portable and can communicate with external entities such as access devices. Examples of user devices include mobile communication devices such as mobile phones, laptop computers, transponders, wearable devices such as smart watches, automobiles with remote communication capabilities, access cards, smart media, etc.

A “mobile communication device” may comprise any suitable electronic device that may be transported and operated by a user, which may also optionally provide remote communication capabilities to a network. Examples of remote communication capabilities include using a mobile phone (wireless) network, wireless data network (e.g., 3G, 4G or similar networks), Wi-Fi, Bluetooth, Bluetooth Low Energy (BLE), Wi-Max, or any other communication medium that may provide access to a network such as the Internet or a private network. Examples of mobile communication devices include mobile phones (e.g., cellular phones), PDAs, tablet computers, net books, laptop computers, wearable devices (e.g., watches), vehicles such as automobiles and motorcycles, personal music players, hand-held specialized readers, etc. A mobile communication device may comprise any suitable hardware and software for performing such functions, and may also include multiple devices or components (e.g., when a device has remote access to a network by tethering to another device—i.e., using the other device as a modem—both devices taken together may be considered a single mobile communication device).

An “authorizing entity” may be an entity that authorizes a request. Examples of an authorizing entity may be an issuer, a governmental agency, a document repository, an access administrator, etc. An authorizing entity may operate an authorizing entity computer. An “issuer” may refer to a business entity (e.g., a bank) that issues and optionally maintains an account for a user. An issuer may also issue payment credentials stored on a user device, such as a cellular telephone, smart card, tablet, or laptop to the consumer.

A “resource provider” may be an entity that can provide a resource such as goods, services, information, and/or access to a location (e.g., a parking space, a transit terminal, etc.). Examples of resource providers include merchants, governmental authorities, secure data providers, etc. A resource provider may operate one or more access devices.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer”.

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “credential” may be any suitable information that serves as reliable evidence of worth, ownership, identity, or authority. A credential may be a string of numbers, letters, or any other suitable characters that may be present or contained in any object or document that can serve as confirmation.

A “value credential” may be information associated with worth. Examples of value credentials include payment credentials, coupon identifiers, information needed to obtain a promotional offer, etc.

“Payment credentials” may include any suitable information associated with an account (e.g., a payment account and/or payment device associated with the account). Such information may be directly related to the account or may be derived from information related to the account. Examples of account information may include a PAN (primary account number or “account number”), username, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors). Payment credentials may be any information that identifies or is associated with a payment account. Payment credentials may be provided to make a payment from a payment account. Payment credentials can also include a username, an expiration date, a gift card number or code, and any other suitable information.

A “token” may be a substitute value for a credential. A token may be a string of numbers, letters, or any other suitable characters. Examples of tokens include access tokens such as payment tokens, data that can be used to access secure systems or locations, etc.

A “payment token” may include an identifier for a payment account that is a substitute for an account identifier, such as a primary account number (PAN) and/or an expiration date. For example, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing transaction processing networks (e.g., ISO 8583 financial transaction message format). In some embodiments, a token may be used in place of a PAN to initiate, authorize, settle or resolve a payment transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which sensitive data is replaced with substitute data. For example, a real credential (e.g., a primary account number (PAN)) may be tokenized by replacing the real account identifier with a substitute number that may be associated with the real credential. Further, tokenization can be applied to any other information to substitute the underlying information with a token. “Token exchange” or “de-tokenization” can be a process of restoring the data that was substituted during tokenization. For example, a token exchange may include replacing a payment token with its associated primary account number (PAN). Further, de-tokenization or token exchange may be applied to any other information to retrieve the substituted information from a token. In some embodiments, token exchange can be achieved via a transactional message, such as an ISO message, an application programming interface (API), or another type of web interface (e.g., web request).

A “token service computer” can include a system that that services tokens. In some embodiments, a token service computer can facilitate requesting, determining (e.g., generating) and/or issuing tokens, as well as maintaining an established mapping of tokens to primary account numbers (PANs) in a repository (e.g., token vault). In some embodiments, the token service computer may establish a token assurance level for a given token to indicate the confidence level of the token to PAN binding. The token service computer may include or be in communication with a token vault where the generated tokens are stored. The token service computer may support token processing of payment transactions submitted using tokens by de-tokenizing the token to obtain the actual PAN.

An “authorization request message” may be a message that requests permission to conduct an interaction. For example, an authorization request message may include an electronic message that is sent to a payment processing network and/or an issuer of a payment card to request authorization for a transaction. An authorization request message according to some embodiments may comply with (International Organization of Standardization) ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message. In some embodiments, it may be generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g., POS equipment) that indicates approval of the transaction. The code may serve as proof of authorization. As noted above, in some embodiments, a payment processing network may generate or forward the authorization response message to the merchant.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

An “application” may be computer code or other data stored on a computer readable medium (e.g., memory element or secure element) that may be executable by a processor to complete a task.

A “digital wallet” can include an electronic device that allows an individual to conduct electronic commerce transactions. A digital wallet may store user profile information, payment credentials, bank account information, one or more digital wallet identifiers and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like. A digital wallet may be designed to streamline the purchase and payment process. A digital wallet may allow the user to load one or more payment cards onto the digital wallet to make a payment without having to enter an account number or present a physical card.

A “digital wallet provider” may include an entity, such as an issuing bank or third party service provider, which issues a digital wallet to a user that enables the user to conduct financial transactions. A digital wallet provider may provide standalone user-facing software applications that store account numbers, or representations of the account numbers (e.g., payment tokens), on behalf of a cardholder (or other user) to facilitate payments at more than one unrelated merchant, perform person-to-person payments, or load financial value into the digital wallet. A digital wallet provider may enable a user to access its account via a personal computer, mobile communication device or access device.

“Transaction data” may include any suitable information surrounding a transaction. Examples of transaction data may include a time and/or data of the transaction, the parties involved in the transaction, the amount of the transaction, the terms of the transaction, the goods, services or rights being transacted, etc.

“Payment transaction data” may refer to any information corresponding to or describing purchases, orders, invoices, payments involving goods, items, services, and/or the like, and may include, but is not limited to, purchase amounts (or “transaction amounts”), merchant identifiers, description codes (e.g., NAICS: North American Industry Classification System) associated with purchased items, costs of purchased items, descriptions of purchased items, purchase dates, indications of payments accounts used, indications as to the mode of purchase (e.g., QR code, online, in person, contactless, etc.), confirmation numbers, order numbers, cancellation numbers, shipment status updates (e.g., order being processed, shipped, delivered, on back order, etc.), delivery tracking numbers, cancellation notices, updates, transaction party identifiers, payment device identifiers, encryption keys, and/or the like.

A “completion page” can be a page such as an electronic page in an application or browser which indicates that a process or a step in a process has been completed. A checkout page is an example of a completion page.

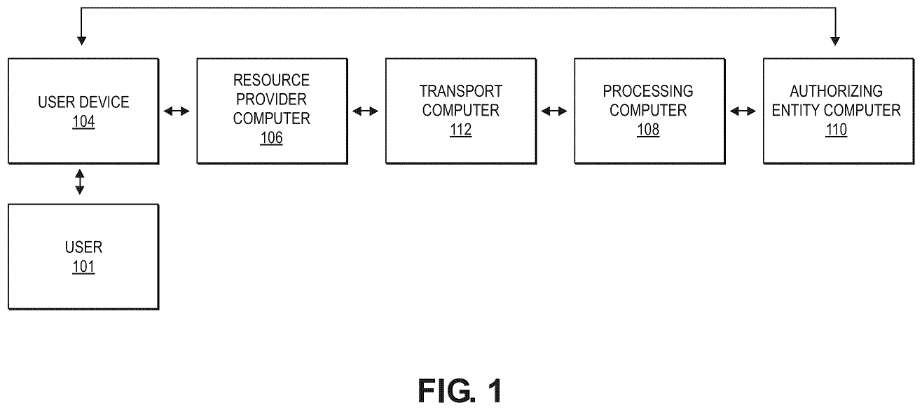

FIG. 1 shows a system according to an embodiment. FIG. 1 shows a user device 104 that is operated by a user 101. The user device 104 may be in communication with a resource provider computer 106. The resource provider computer 106 can be in communication with an authorizing entity computer 110 via a transport computer 112 and a processing computer 108.

The resource provider computer 106 may be a merchant computer that operates a merchant website. The resource provider computer 106 may be configured to generate an authorization request message for a transaction that is conducted between the resource provider operating the resource provider computer 106 and the user 101.

The transport computer 112 may be operated by an entity such as an acquirer. An acquirer is typically a system for an entity (e.g., a bank) that has a business relationship with a particular merchant, a wallet provider or another entity. The transport computer 112 may be communicatively coupled to the resource provider computer 106 and the processing computer 108 and may issue and manage an account of the resource provider (e.g., a merchant). In some embodiments, the transport computer 112 may forward the authorization request message to the processing computer 108 and an authorization response message to the resource provider computer 106 during a transaction to confirm processing of a payment transaction.

The processing computer 108 may be configured to provide authorization services and clearing and settlement services for payment transactions. The processing computer 108 may include data processing subsystems, networks, and operations used to support and deliver authorization services, exception file services, and clearing and settlement services. An exemplary payment processing network may include VisaNet™. Payment processing networks such as VisaNet™ can process credit card transactions, debit card transactions, and other types of commercial transactions. VisaNet™, includes a Visa Integrated Payments (VIP) system which processes authorization requests and a Base II system which performs clearing and settlement services. Furthermore, the payment processing network may include a server computer and may use any suitable wired or wireless telecommunications network, including the Internet. In some embodiments, the processing computer 108 may forward an authorization request received from the transport computer 112 to the authorizing entity computer 110 via a communication channel. The processing computer 108 may further forward an authorization response message received from the authorizing entity computer 110 to the transport computer 112.

In some embodiments, the authorizing entity computer 110 may be operated by an account issuer. Typically the issuer is an entity (e.g., a bank) that issues and maintains an account of the user 101. The account may be a credit, debit, prepaid, or any other type of account.

Each of the entities in FIG. 1 may communicate through any suitable communication channel or communications network. A suitable communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

Note that embodiments are not limited to the particular system in FIG. 1, and that a system according to embodiments can have more or less computers, performing different functions. For example, in some embodiments, the resource provider computer 106 may be operated by an entity such as a governmental agency or a secure data access entity. In such embodiments, the transport computer 112, the processing computer 108, and the authorizing entity computer 110 may not be needed in such embodiments.

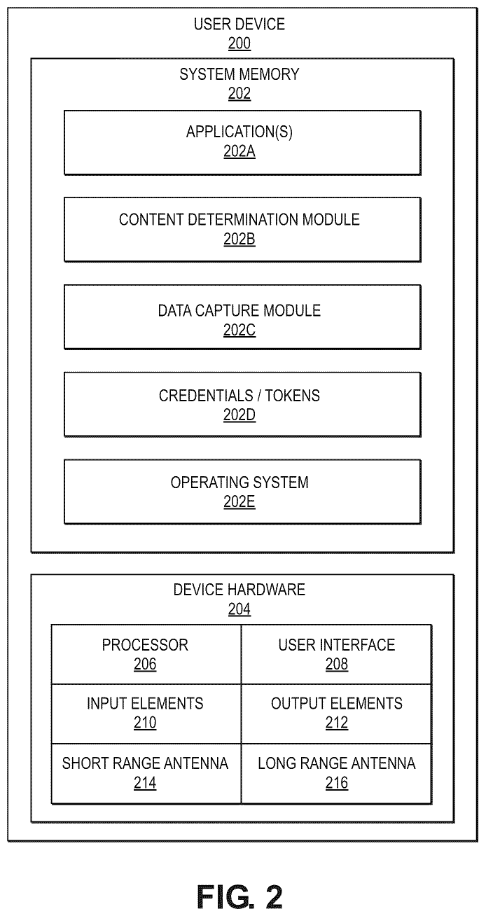

FIG. 2 illustrates a user device 200 according to an embodiment. User device 200 may include device hardware 204 coupled to a system memory 202.

Device hardware 204 may include a processor 206, a short range antenna 214, a long range antenna 216, input elements 210, a user interface 208, and output elements 212 (which may be part of the user interface 208). Examples of input elements may include microphones, keypads, touchscreens, sensors, etc. Examples of output elements may include speakers, display screens, and tactile devices. The processor 206 can be implemented as one or more integrated circuits (e.g., one or more single core or multicore microprocessors and/or microcontrollers) and is used to control the operation of user device 200. The processor 206 can execute a variety of programs in response to program code or computer-readable code stored in the system memory 202 and can maintain multiple concurrently executing programs or processes.

The long range antenna 216 may include one or more RF transceivers and/or connectors that can be used by user device 200 to communicate with other devices and/or to connect with external networks. The user interface 208 can include any combination of input and output elements to allow a user to interact with and invoke the functionalities of user device 200. The short range antenna 809 may be configured to communicate with external entities through a short range communication medium (e.g., using Bluetooth, Wi-Fi, infrared, NFC, etc.). The long range antenna 819 may be configured to communicate with a remote base station and a remote cellular or data network, over the air.

The system memory 202 can be implemented using any combination of any number of non-volatile memories (e.g., flash memory) and volatile memories (e.g., DRAM, SRAM), or any other non-transitory storage medium, or a combination thereof media. The system memory 202 may store computer code, executable by the processor 206, for performing any of the functions described herein.

The system memory 202 may also store application(s) 202A, a content determination module 202B, a data capture module 202C, credentials/tokens 202D, and an operating system 202E,

The application(s) 202A may include applications that can perform specified functions. Some examples of applications include resource provider applications (e.g., merchant applications), digital wallet applications, authorizing entity applications (e.g., issuer applications), browsers, social media applications, etc.

The content determination module 202B may comprise code, executable by the processor 206, to determine the content on a page or user interface being displayed to the user of the user device 200. The content determination module 202B can include character recognition software. The content determination module 202B can also include software such as a machine learning algorithm (e.g., a neural network such as a recurrent neural network, a classification and regression tree, a support vector machine, etc.) that can classify the type of page or user interface that is being presented to the user based on the recognized content. For instance, based on the content of a user interface such as an application page or Web page, the content determination module 202B and the processor 206 can determine (e.g., classify), based on the words, images, or other features on the page, that the particular page is a completion page such as a checkout page. For instance, the words “Thank you for your purchase,” “confirmation,” “total,” and the like on a page may indicate that the page is a checkout page. Also, the position of the page in a set of operational pages may also be a feature used in the machine learning algorithm. For instance, an introductory page in a set of operational pages is unlikely to be a completion page, whereas a later page in a set of operational pages is more likely to be a completion page. In other embodiments, the content on the page may be used by machine learning algorithm to classify the page as a non-completion page such as an introductory page, a help page, an error page, etc. Feedback data regarding the correctness or incorrectness of any classifications may be used to train the machine learning algorithm, such that the machine learning algorithm continually learns.

The data capture module 202C may comprise code, executable by the processor 206, to capture data from a page. In some embodiments, the data capture module 202C and the processor 206 can automatically capture an image of a page in response to a classification of a page type by the content determination module 202B and the processor 206. For example, upon detection by the content determination module 202B and the processor 206 that a page being viewed by the user is a completion page, the data capture module 202C can automatically capture the image of the page and can store the image data in the memory 202. The captured images may be associated with image data in any suitable format including, but not limited to JPEG, GIF, or PDF files. The data capture module 202C and the processor 206 may also determine and store metadata associated with any captured image. In some embodiments, metadata associated with a captured image can include the time when the image was captured, the type of device that captured the image, the particular application identifier that was operating on the user device when the image was captured, etc.

System memory 202 may also store credentials and/or tokens 202D. Credentials may also include information identifying the user device 200 and/or the user of the user device 200.

In some embodiments, the memory 202 may comprise a non-transitory computer readable medium 304 containing instructions for causing the processor to perform operations comprising: presenting a completion page for a transaction to a user; capturing an image of the completion page; storing completion page image data for the image of the completion page; and presenting transaction data for the transaction along with mage of the completion page to the user, the image of the completion page generated using the stored completion page image data.

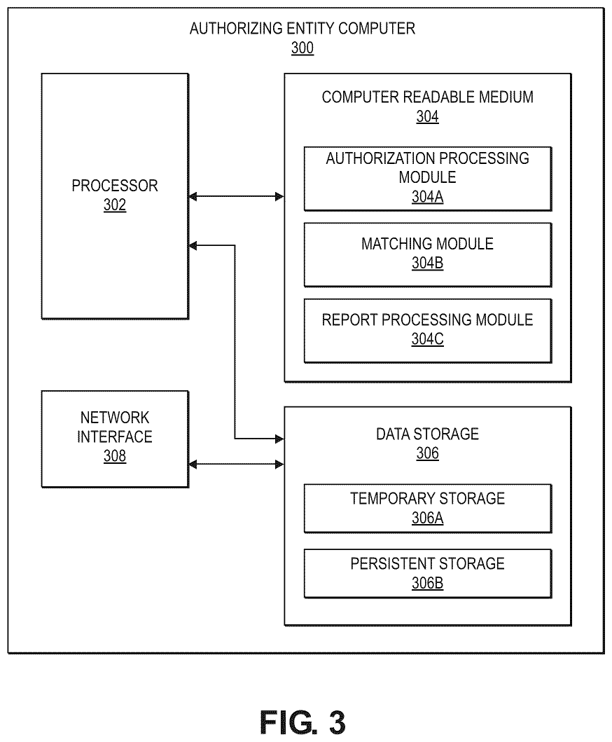

FIG. 3 shows a block diagram of an authorizing entity computer according to an embodiment.

The authorizing entity computer 300 may comprise a processor 302, which may be coupled to a computer readable medium 304, a data storage 306, and a network interface 308.

The data storage 306 may store transaction data, image data and metadata thereof, access data such as tokens and/or account data, as well as mappings between access data, credentials, and/or communication device identifiers such as phone numbers, IP addresses, device identifiers, etc.

The data storage 306 may comprise one or more memory devices and may contain a temporary storage 306A and a persistent storage 306B. The temporary storage 306A can temporarily store transaction data, and image data and metadata thereof for a predetermined amount of time (e.g., 2 months) when image data is being matched to transaction data. In some embodiments, the temporary storage 306A can store any matched image data and metadata thereof with the corresponding transaction data in the persistent storage 306B and can delete such data from the temporary storage 306A.

The computer readable medium 304 may comprise several software modules including an authorization processing module 304A, a matching module 304B, and a report processing module 304C. The computer readable medium may also comprise a clearing and settlement module (not shown).

The authorization processing module 304A may comprise code that can cause the processor 302 to evaluate authorization request messages for transactions and determine if the transactions should be authorized. The authorization processing module 304A may also include code for routing or modifying authorization request and response messages as they pass between various parties such as authorizing entity computers (e.g., issuer computers) and transport computers (e.g., acquirer computers).

The matching module 304B may include code, executable by the processor 302 to match transaction data with image data and/or metadata associated with the image data. The matching module 304B and the processor 302 can compare aspects of the image data and/or the metadata to the transaction data to determine if they match. For example, image data from a user device may have metadata such as a time (e.g., 2:00 pm on 1/2/22) when the image was taken and a transaction amount and merchant name that was determined during the content determination process described above. The transaction data stored by the authorizing entity computer 300 may include a transaction for the same amount and the same merchant that was authorized by the authorizing entity computer 300 at 2:01 pm on 1/2/22. The matching module 304B can match these data items as they are likely associated with the same transaction, and can link and store them in the data storage 306.

The report processing module 304C may comprise code that causes the processor 302 to generate a report with transaction data and the images, or access to the images (e.g., such as through a hyperlink).

In some embodiments, the matching module 304B and the report processing module 304C can be software modules on an application such as an authorizing entity application on the user device instead of or in addition to the authorizing entity computer 300.

In some embodiments, the computer readable medium 304 may comprise receiving, from a user device, completion page image data for an image of a completion page associated with a transaction conducted by a user; receiving an authorization request message for the transaction; determining transaction data based on the authorization request message; matching the completion page image data for the image of the completion page with the transaction data; and providing the transaction data for the transaction along with the image of the completion page to the user.

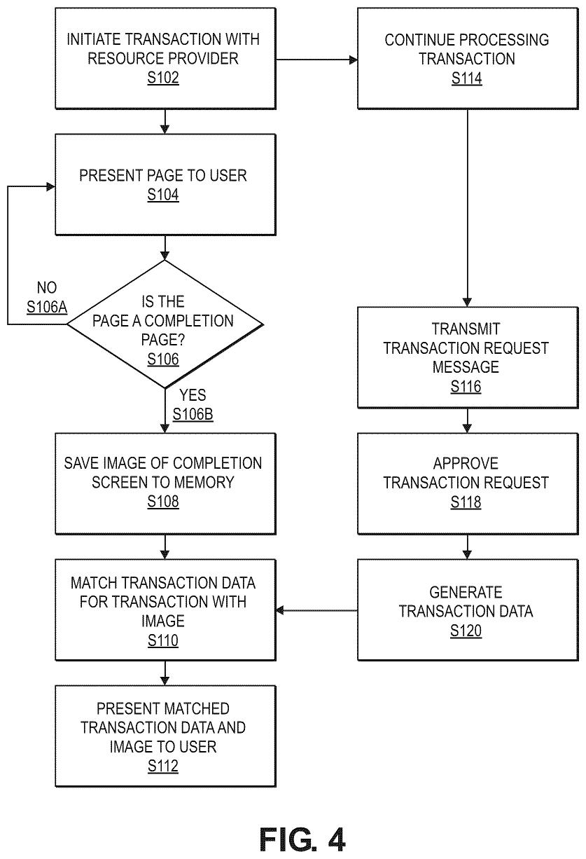

FIG. 4 shows a flowchart illustrating methods according to embodiments.

In step S102, a user 101 using a user device 104 can initiate a transaction with a resource provider operating a resource provider computer 106. In some embodiments, the user may use an application such as a resource provider application or an authorizing entity application to initiate the transaction with the resource provider operating the resource provider computer 106. In other embodiments, the user can contact a Web site of the resource provider operating the resource provider computer 106 using a browser on the user device 104. The user 101 may be conducting a transaction such as a purchase transaction, a registration process, a data entry process, a refund process, or the like with the resource provider.

In some embodiments, the method includes automatically determining, by the user device, the completion page from a plurality of pages of a resource provider site on a resource provider computer by scanning the text, graphics, or other elements on each of the plurality of operational pages and determining that the completion page meets completion page criteria and/or is classified as a completion page.

In step S104, one of many pages (e.g., user interface screens) is presented to the user. The pages may be operational pages on a website, an application on the user device (e.g., a resource provider application or an authorizing entity application on the user device), etc.

In step S106, the content determination module in the user device 104 can automatically determine if the user interface screen is a completion screen such as a transaction completion screen (e.g., a transaction checkout page). The content determination module in the user device 104 can use a URL or/and scan and analyze the content (including the text, graphics, and data input fields) to determine if the page (e.g., the user interface screen) being analyzed is a completion screen. As explained above, the content determination module can include software such as a machine learning algorithm (e.g., a neural network) that can classify the type of page or user interface that is being presented to the user based on the recognized page content. For instance, based on the content of a user interface such as an application page or Web page, the content determination module can determine, based on the words, images, or other features on the page, that the particular page is a completion page. In the case of a URL, the URL may contain words such as “completion”, “confirmation” and the like, which may indicate that the page is a completion page. The page may contain words such as “Thank you for your purchase,” “confirmation,” “total,” and the like, which may indicate that the page is a completion page. Other operational pages that may not have such words, images, or features may be other type of operational pages such as introductory pages, help pages, data entry pages, etc. The machine learning algorithm can learn which features (e.g., words, images, and other page elements) which would characteristic of a completion page and can classify pages as being completion pages or other types of pages. The machine learning algorithm can have a feedback loop which can adjust (e.g., weights of neurons) based on feedback from end users as to whether or not the pages were in fact completion pages. The machine learning algorithm may exist solely on the user device 104 or link to a centralized machine learning algorithm. In yet other embodiments, the content determination module in the user device 104 could access a central database to retrieve data which indicates which of the operational pages is the completion page. For instance, data from the central database could indicate that a completion page would include certain words or other data.

In other embodiments, the automatic determination of whether a page is a completion page, or another type of page can be based on certain pre-defined criteria. For example, if a particular type of resource provider is recognized by the content determination module, then that resource provider may have a page that has specific elements that are indicative of a completion page for that service provider. For example, the content determination module may be programmed to recognize that the user and the user device 104 is interacting with a particular merchant. That merchant may be known by the content determination module to have the specific words and confirmation numbers in a specific format (e.g., alternating letters and numbers). The content determination module can recognize that a page with the specific words and the specific confirmation number type is a completion page.

If the user interface screen is not a completion page, then in step S106A, the method proceeds back to step S104 and another page is presented to the user. this process is repeated until a completion page is found.

If the content determination module in the user device 104 does determine that the user interface screen is a completion page, then in step S106B, the method proceeds to step S108 where the data capture module of the user device 104 captures an image of the completion screen and stores it in the memory in the user device. The image of the completion screen may be stored as completion page image data. The completion page image data may be in any suitable image data format including the form of a JPEG, PNV, GIF, or PNG file. In addition, metadata of the captured completion image may also be stored in the memory along with the completion image data. Examples of metadata may include the time when the completion page image was captured, an identifier for the resource provider with which the user is interacting (e.g., a Web site address, an application identifier, a resource provider name), an identifier for the user device (e.g., an IP address, a SIM card number, etc.), an operating system identifier for the user device, and the like. Metadata may also include specific content on the completion page (e.g., a transaction amount, a confirmation number, etc.).

In some embodiments, the user device 104, in addition to storing the completion page image data and the metadata locally, can provide the completion page image data of the completion page and the metadata thereof to a server computer such as the authorizing entity computer 110. As will be explained below, in some embodiments, the server computer matches the completion page image data or metadata thereof to the transaction data for the transaction. The user device can then present the transaction data for the transaction along with the completion page to the user by displaying the transaction data for the transaction along with the completion page on a website of the authorizing entity computer 110.

In step S114, in some embodiments, before, simultaneously with or after the completion screen is presented to the user by the user device 104, the user device 104 or the resource provider computer 106 can continue transaction processing. At some point in time during transaction processing, the user of the user device 104 will enter data which may result in the generation of a transaction request message such as an authorization request message that requests approval of the transaction. For example, in a payment example, the user may click a “submit order” button on a displayed page after providing any payment credentials or tokens.

In step S114, in some embodiments, the resource provider computer 106 can transmit the transaction request message to an authorizing entity computer 100 via the transport computer 112 and the processing computer 108. If a token is present, in the authorization request message, the processing computer 108 can exchange the token for a real credential such as a primary account number and can modify the authorization request message with the real credential before sending it to the authorizing entity computer 110. In other embodiments, the resource provider computer 106 could perform the authorization and the generation and transmission of the transaction request message in steps S116 and S118 would not be needed.

At step S118, after receiving the transaction request message (e.g., the authorization request message), the authorizing entity computer 110 can approve the transaction request if the transaction appears to be authentic and legitimate. The authorizing entity computer 110 can then transmit a transaction response message such as an authorization response message back to the resource provider computer 106 via the transport computer 112 and the processing computer 108.

In step S120, the authorizing entity computer 110 may generate the transaction data after the transaction request message is approved. The transaction data could include an amount, a time, a resource provider identifier, an approval code, and other information. In some cases, the authorizing entity computer 110 can provide the transaction data to the user device 104, such as in the case where the user device 104 has an authorizing entity application which is serviced by the authorizing entity computer 110.

The authorizing entity computer 110 can then generate and transmit an authorization response message back to the resource provider computer 106 via the processing computer 108 and the transport computer 112. The receipt of the authorization response message by the resource provider computer 106 may subsequently cause the user device 104 to generate and display the completion page indicating that the transaction is complete. For example, the resource provider computer 106 may be an application server communicating with a resource provider application on the user device 104 and upon receipt of the authorization request message, may generate the completion page. In another example, the resource provider computer 106 may be a Web server that hosts a merchant website, which displays a completion page after receiving the authorization response message.

In step S110, after the transaction data is saved and the completion page image data and its metadata are also saved, a matching process takes place to match the image data and the metadata to the transaction data. For example, image data from a user device may have metadata such as a time (e.g., 2:00 pm on 1/2/22) when the image was taken and a transaction amount and merchant name that was determined during the content determination process described above. The transaction data stored by the authorizing entity computer 300 may include a transaction for the same amount and the same merchant that was authorized by the authorizing entity computer 300 at 2:01 pm on 1/2/22. These two data items can be matched, since they are likely associated with the same transaction. Note that step S110 can be performed by any suitable entity including the authorizing entity computer 110 and/or the user device 104.

In some embodiments, the user device 104 could save the completion page image data to a local memory, and send the metadata of the saved completion page image data to the authorizing entity computer 110. The authorizing entity computer 110 can use the metadata to find the transaction data and send it to the user device 104. The user device may then use the metadata to locate the completion page image data stored on the user device 104. The user device 104 may then display the image of the completion page along with the transaction data received from the authorizing entity computer 110. Such embodiments are advantageous, since the specific data on the completion page is not shared with the authorizing entity computer 110, thereby preserving the privacy of the user of the user device 104.

After the completion page image data and the transaction data for the specific transaction are matched, the matched data can be stored in a database. The database may be in the user device 104 or the authorizing entity computer 110.

In step S112, the matched transaction data and the image of the completion page are then presented to the user. In some embodiments, the user device displays the transaction data for the transaction along with the image of the completion page in a report on a website of an authorizing entity that operates that operates a server computer such as the authorizing entity computer 110. In some embodiments, the image of the completion page may be accessed via a hyperlink that is proximate to the transaction data in the report. The user can select the hyperlink to retrieve the image of the completion page (e.g., from the data stored in the user device 104 or from the authorizing entity computer 110). In some embodiments, the user device displays the transaction data for the transaction along with the completion page in a report on an application that resides on the user device. In yet other embodiments, the matched transaction data and the image of the completion page can be in a list of transactions that is in paper and is presented to the user.

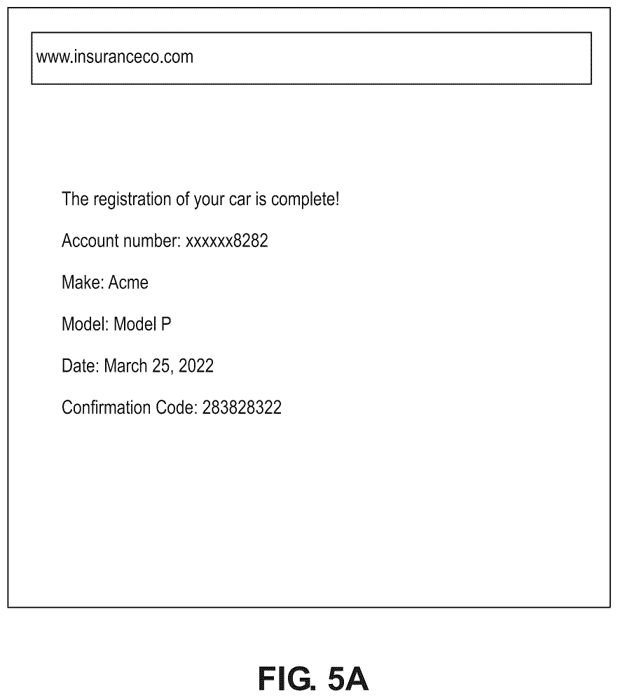

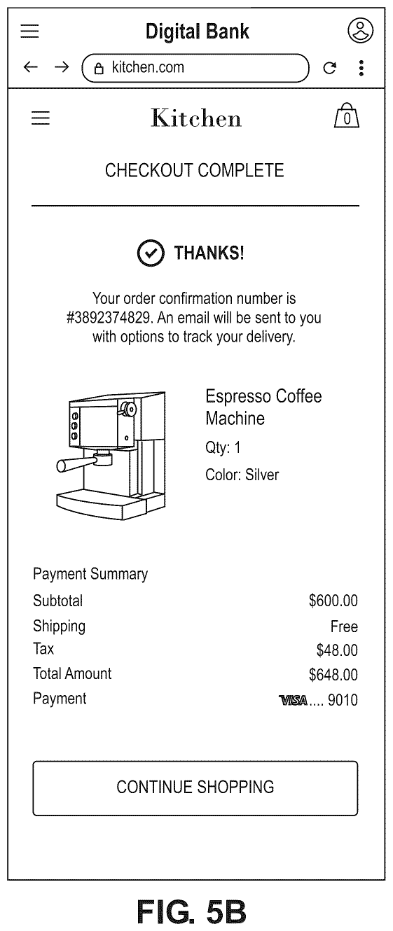

FIG. 5A shows another exemplary completion page according to embodiments. The completion page is associated with a user that registers a car on with an insurance provider operating an insurance provider Website. Data elements which may indicate that the page is a completion page can include the words “confirmation code” and “complete.”

FIG. 5B shows another exemplary completion page according to embodiments. Some data elements that may indicate that this is a completion page may include the use of the words “Thanks!”, total amount,” and “confirmation number” in the text of the page.

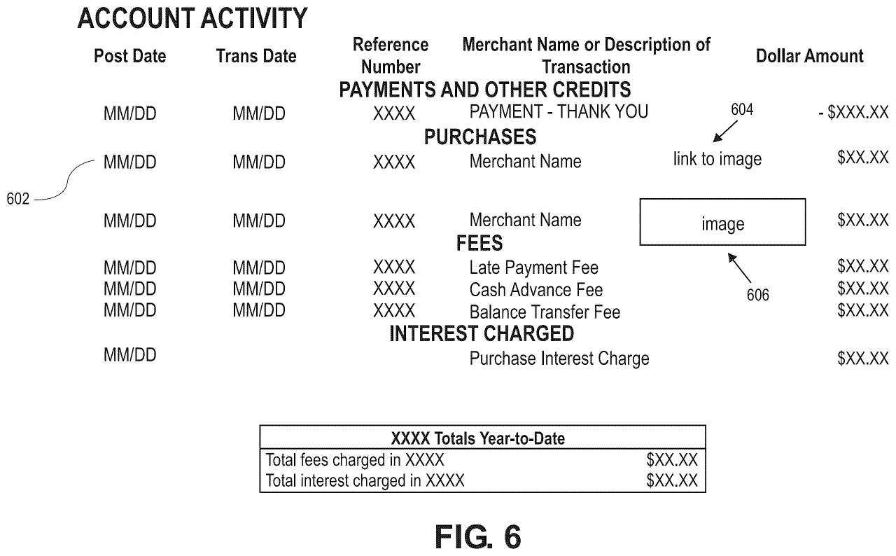

FIG. 6 shows an example of a report that includes data for specific transaction data for transactions 602 and links 604 to images of the completion pages for the transactions or images 606 of the completion pages. The report illustrated in FIG. 6 can be present on an application on a user's user device, or on a Web site of a server computer such as an authorizing entity computer, or even in paper form. If there are links 604 to images, the image data for the images may be stored on the user device or the server computer, and may be retrieved using the links 604.

In some specific embodiments, an issuer application containing a shopping portal can track where the user is in the transaction flow and could automatically take and store a screenshot of an order confirmation page, when detected. This can prevent the sharing of shopping data with the issuer. The application could then store the screenshots locally (on the user device). The issuer could, on the backend, log the time of the screenshot and the name of the merchant. The issuer could link/match this information with the time and merchant name in a submitted transaction such that when a user views their online statement on the same device, the issuer could present a link to the locally stored screenshot. In an alternative embodiment, the screenshot could also be uploaded to the issuer and be linked to the transaction history stored by issuer for later viewing by the cardholder from the issuer app or from the issuer web site.

When shopping from a browser, an issuer provided plug-in could be used to track where the user is in the transaction flow and, when an order confirmation page is being presented, provide an option for the user to consent to a screenshot of the page to be shared with their issuer. Merchants could also provide the option to share confirmation page information with the issuer. That is, some merchants already provide an option to have a confirmation page delivered to an email and the consumer could use an email provided to them by their issuer. Alternatively, merchant could add an option to select from a list of issuers to whom the page will be delivered.

Embodiments of the invention have several technical advantages. Embodiments of the invention can allow a user to obtain a listing of any electronic interactions that they may have had with a particular entity, along with transaction completion images associated with those transactions or access thereto without any user input. By doing so, the end user will be able to recall the performance of each transaction in the list, thereby preventing or reducing the likelihood that the user will be unfamiliar with transactions when they are reviewed on a report.

Also, in some cases, users conducting transactions such as e-commerce or in-app payment transactions may also not recognize the transactions that may be listed on a statement or transaction list. For example, in some cases, the name of the resource providers on the statement may be different than the common name for the resource providers. In one specific example, a transaction may be conducted with a specific restaurant that has a specific trade name, but the name of the provider on the statement that lists the transaction may be the name of the parent company associated with that specific restaurant. The user is likely to contact an authorizing entity (e.g., an issuer) that holds the account that the user uses to conduct the transactions to request clarification on the transactions or to request a credit due to suspected fraudulent activity. This can be problematic when the transactions that are conducted are actually legitimate and can unnecessarily waste resources.

However, the completion page that is automatically saved and re-presented to the user in embodiments of the invention can refresh the user's memory regarding the specifics of the transactions listed on the statement.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
presenting, by a user device, a completion page for a transaction to a user;
capturing, by the user device, an image of the completion page;
storing, by the user device, completion page image data for the image of the completion page; and
presenting, by the user device, transaction data for the transaction along with the image of the completion page to the user, the image of the completion page generated using the stored completion page image data.

2. The method of claim 1, further comprising:
providing, by the user device, the completion page image data of the completion page to a server computer, wherein the server computer matches the completion page image data to the transaction data for the transaction, and wherein presenting, by the user device, the transaction data for the transaction along with the image of the completion page to the user comprises displaying the transaction data for the transaction along with the image of the completion page on a Website of an authorizing entity that operates the server computer.

3. The method of claim 1, wherein presenting, by the user device, the transaction data for the transaction along with the image of the completion page to the user comprises displaying the transaction data for the transaction along with the image of the completion page on an application that resides on the user device.

4. The method of claim 1, further comprising:
providing, by the user device, completion page image metadata of the completion page to a server computer, wherein the server computer matches the completion page image metadata to the transaction data for the transaction, and
using the completion page image metadata to identify the image of the completion page stored in the user device.

5. The method of claim 1, further comprising:
matching, by the user device, completion page image metadata to the transaction data to match the image of the completion page to the transaction data.

6. The method of claim 1, further comprising:
automatically determining, by the user device, the completion page from a plurality of operational pages.

7. The method of claim 1, further comprising:
accessing a centralized database, by the user device, to retrieve data indicating which of a plurality of operational pages is the completion page.

8. The method of claim 1, further comprising:
automatically determining, by a trained machine learning model associated with the user device, the completion page from a plurality of operational pages.

9. A user device comprising:
a processor; and
a non-transitory computer readable medium coupled to the processor and containing instructions for causing the processor to perform operations comprising:
presenting a completion page for a transaction to a user;
capturing an image of the completion page;
storing completion page image data for the image of the completion page; and
presenting transaction data for the transaction along with the image of the completion page to the user, the image of the completion page generated using the stored completion page image data.

10. The user device of claim 9, wherein the operations further comprise:
providing the completion page image data of the completion page or metadata thereof to a server computer, wherein the server computer matches the completion page image data or the metadata thereof to the transaction data for the transaction, and wherein presenting the transaction data for the transaction along with the image of the completion page to the user comprises displaying the transaction data for the transaction along with the image of the completion page on a Website of an authorizing entity that operates that operates the server computer.

11. The user device of claim 9, wherein the operations further comprise:
automatically determining, by a neural network associated with the user device, the completion page from a plurality of operational pages.

12. The user device of claim 9, wherein the operations further comprise:
providing, by the user device, completion page image metadata of the completion page to a server computer, wherein the server computer matches the completion page image metadata to the transaction data for the transaction, and
using the completion page image metadata to identify the completion page image data stored by the user device to display the image of the completion page.

13. The user device of claim 9, wherein the operations further comprise:
receiving a selection of a hyperlink that causes the user device to retrieve the stored completion page image data and generate the image of the completion page and display the image of the completion page with the transaction data.

14. The user device of claim 9, wherein the operations further comprise:
automatically determining, by the user device, the completion page from a plurality of operational pages of a resource provider site on a resource provider computer by scanning text on each of the plurality of operational pages and determining that the completion page meets completion page criteria.

15. The user device of claim 9, wherein the operations further comprise:
matching, by the user device, metadata associated with the completion page image data to the transaction data to match the completion page to the transaction data, wherein the metadata comprises a time and date when the completion page image data was created.

16. A method comprising:
receiving, by an authorizing entity computer from a user device, completion page image data for an image of a completion page associated with a transaction conducted by a user;
receiving, by the authorizing entity computer, an authorization request message for the transaction;
determining, by the authorizing entity computer, transaction data based on the authorization request message;
matching, by the authorizing entity computer, the completion page image data for the image of the completion page with the transaction data; and
providing, by the authorizing entity computer to the user device, the transaction data for the transaction along with the image of the completion page.

17. The method of claim 16, wherein the transaction data and the completion page are provided to the user device via an authorizing entity application on the user device.

18. The method of claim 16, wherein the transaction data and the completion page are provided to the user device via a browser using an authorizing entity host site on the authorizing entity computer.

19. The method of claim 16, further comprising:
receiving, by the authorizing entity computer, metadata associated with the completion page, and wherein matching the completion page image data for the image of the completion page with the transaction data comprises using the metadata to determine the transaction data matched with the completion page image data.

20. The method of claim 16, wherein the completion page image data is in a JPEG, PNV, GIF, or PNG file.
